(19) United States
(12) Patent Application Publication
(10) Pub. No.: US 2004/0147245 A1
(43) Pub. Date: Jul. 29, 2004

(54) Method for deducting for services provided in a computer network

(76) Inventors: Georg Kastelewicz, Berlin (DE); Peter Kim, Berlin (DE)

Correspondence Address: MORRISON & FOERSTER LLP, 1650 TYSONS BOULEVARD, SUITE 300, MCLEAN, VA, 22102, US

(21) Appl. No.: 10/477,421

(22) PCT Filed: Apr. 22, 2002
(86) PCT No.: PCT/DE02/01543

(30) Foreign Application Priority Data
May 14, 2001 (DE) 101 25 052.5

(51) Int. Cl. H04M 11/00

(52) U.S. Cl. 455/406

(57) ABSTRACT

The invention relates to a method for deducting for services provided in a computer network. The aim of the invention is to be able to deduct for services in a manner that is simple and reliable for a service provider and for a service user. To this end, the invention provides that during the use of a service by a service user residing within in a first telecommunications network, a deduction message, which is provided with an identifier of the service user, is transmitted by a service provider node of the computer network to a clearing facility of another telecommunications network, which can be connected to the computer network. Based on the identifier of the service user, a billing message provided with the identifier of the service user is transmitted from the other telecommunications network to an account processing facility of the first telecommunications network of the service user via a signaling system that controls telecommunications connections, and the account processing facility deducts for the use of the service from a credit account assigned to the service user.

The invention relates to a method for billing for services provided in a computer network.

There is currently a wide diversity of services provided in computer networks (for example on the Internet). Such services include, by way of example, the sale of goods of all types, of information, and business and entertainment services. In this case, providers of such services are not just large companies but also small companies which appear and disappear quickly and have limited resources for their own collection.

There is currently no widespread and generally recognized method for billing (charging) for services provided on the Internet. For very small sums (“micropayments”) and for larger sums of money (“macropayments”) there is the need for a secure, simple and cheap payment method.

The invention is based on the object of specifying a method for billing for services provided in a computer network which can be used to bill for such services in a manner which is simple and reliable for a service provider and a service user.

This object is achieved for a method of the type specified at the outset by virtue of service use by a service user domiciled in a first telecommunication network involving a service provider node in the computer network sending a billing message, provided with an identification for the service user, to a billing device in a further telecommunication network which can be connected to the computer network, the further telecommunication network taking the service user's identification as a basis for using a telecommunication-connection controlling signaling system to send a charging message, provided with the service user's identification, to an account management device in the service user's first telecommunication network, and the account management device billing for the service use via a credit account associated with the service user. A particular advantage in this context is that the service provider node DAK effects the billing by always sending the billing message to one further telecommunication network which can be connected to the computer network, and this is done regardless of the telecommunication network in which the service user is domiciled (i.e. the telecommunication network operator with whom the service user has made an agreement and the telecommunication network in which the account management device with the user's credit account is therefore situated). Advantageously, the connection (required for the billing) between the first telecommunication network and the further telecommunication network is provided using a signaling system which is used for call setup, for call control and for call cleardown on telecommunication connections between the telecommunication networks. This means that the transport of the charging messages does not require any additional network elements in the telecommunication networks, and it is possible to use the addressing, routing and security mechanisms which are used for telecommunication-connection controlling signaling connections anyway.

The inventive method can be in a form such that the first telecommunication network and/or the further telecommunication network are operated according to UMTS guidelines. This is advantageous particularly because UMTS telecommunication networks contain a telecommunication-connection controlling signaling system (also called SIP session control).

The inventive method can be in a form such that the charging message is routed to the account management device by a packet-oriented message routing mechanism in the signaling system.

It is advantageously possible to use a signaling system in which a message transmission protocol called “Session Initiation Protocol” is applied.

The inventive method can also be in a form such the computer network is connected to the further telecommunication network by means of a Parlay network connection node or by means of an OSA network connection node. In this context, a particular advantage is that the Parlay or OSA technology provides a ready-to-use technology in order to connect telecommunication networks to elements which are foreign to telecommunication networks.

The inventive method can also be in a form such that before the billing message is sent the service provider node receives a service request message with the service user's identification, the service provider node then creates a reservation message with a reservation sum associated with the requested service, this reservation message is sent together with the service user's identification to the billing device in the further telecommunication network, the further telecommunication network uses the telecommunication-connection controlling signaling system to send a reservation request message, provided with the service user's identification and with the reservation sum, to the account management device, and upon successful reservation the account management device sends a reservation request confirmation to the billing device via the signaling connection, the service provider node then creates the billing message and provides the service.

It is likewise possible for the method to be in a form such that before the billing message is sent a network computer associated with the service user is used to send a service request message to the service provider node, an intermediate node arranged between the network computer and the service provider node on the basis of message flow routes a payment flagging message, provided with an identifier for the service user, to the account management device in the first telecommunication network, this account management device replaces the identifier with the service user's identification, the altered payment flagging message is then routed to the billing device in the further telecommunication network via the telecommunication-connection controlling signaling system, the billing device stores the identification and confirms receipt of the altered payment flagging message to the intermediate node by sending a payment flagging confirmation which contains the identification, the intermediate node then forwards the service request message together with the identification to the service provider node, and the service provider node then creates the billing message and provides the service. A particular advantage in this context is.. that the account management device's replacement of the service user's identifier with the service user's identification allows the identity of the service user to be hidden from the service provider, with the service provider nevertheless being able to bill for his services securely and reliably.

The inventive method can also be in a form such that before the billing message is sent a communication terminal associated with the service user is used to route a payment flagging message, provided with an identifier for the service user, to the account management device in the first telecommunication network, this account management device replaces the identifier with the service user's identification, the altered payment flagging message is then routed to the billing device in the further telecommunication network via the telecommunication-connection controlling signaling system, the billing device stores the identification and confirms receipt of the altered payment flagging message to the communication terminal by sending a payment flagging confirmation which contains the identification, the communication terminal then forwards a service request message together with the identification to the service provider node, and the service provider node then creates the billing message and provides the service.

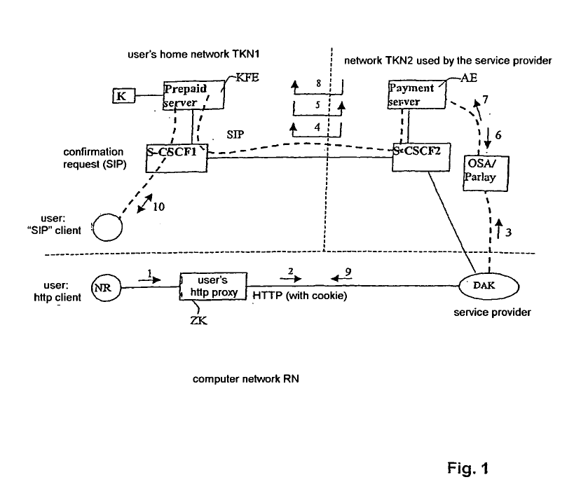

To explain the invention further, FIGS. 1 to 6 below show exemplary embodiments which describe the inventive method.

FIG. 1 shows a schematic illustration of network elements with message flows for carrying out the inventive method,

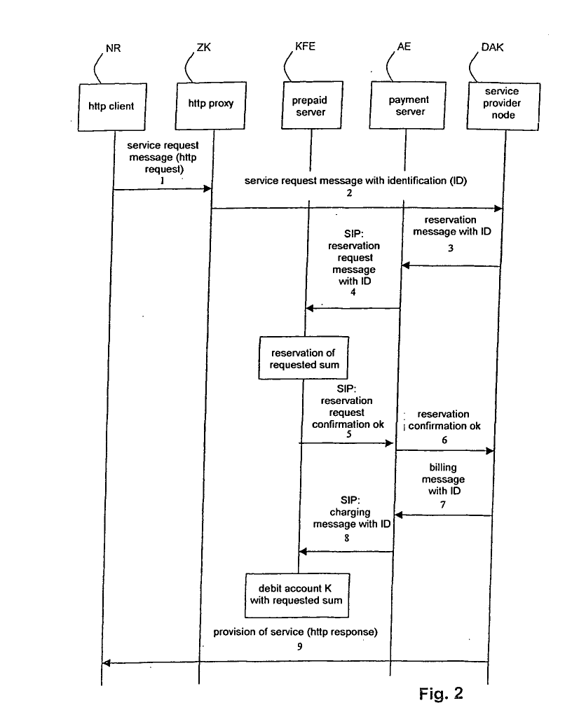

FIG. 2 shows a graphical illustration of the message flows taking place between the network elements in line with FIG. 1,

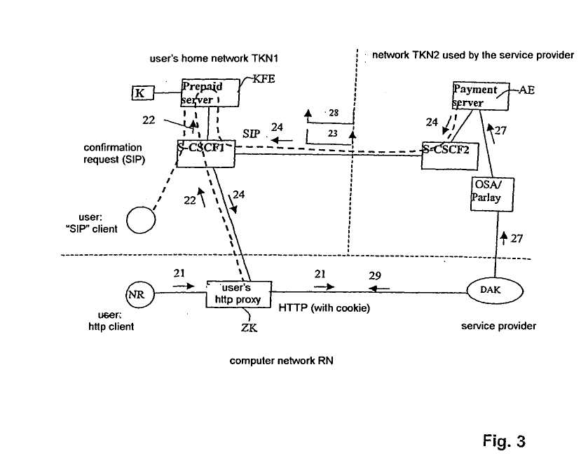

FIG. 3 shows a schematic illustration of network elements with further message flows for carrying out the inventive method,

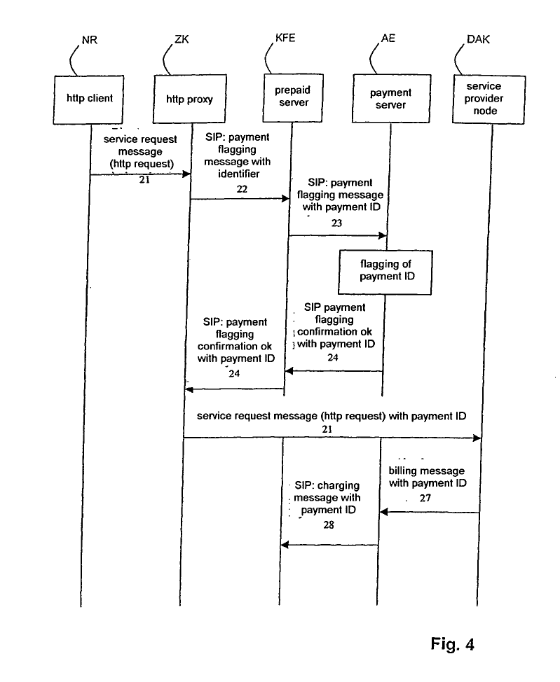

FIG. 4 shows. a graphical illustration of the message flows corresponding to FIG. 3,

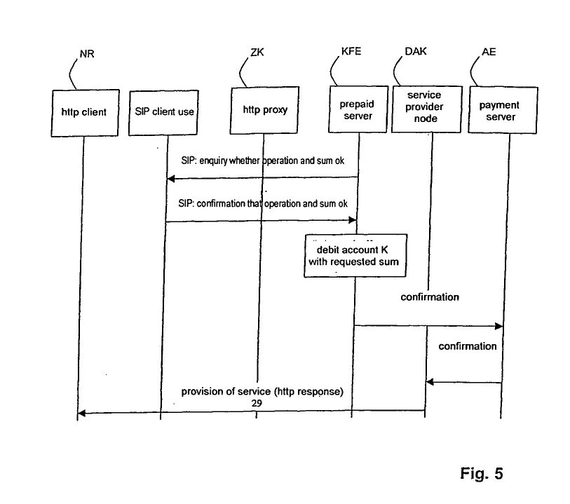

FIG. 5 likewise shows a graphical illustration of message flows which follow on from the message flows in FIG. 4, and

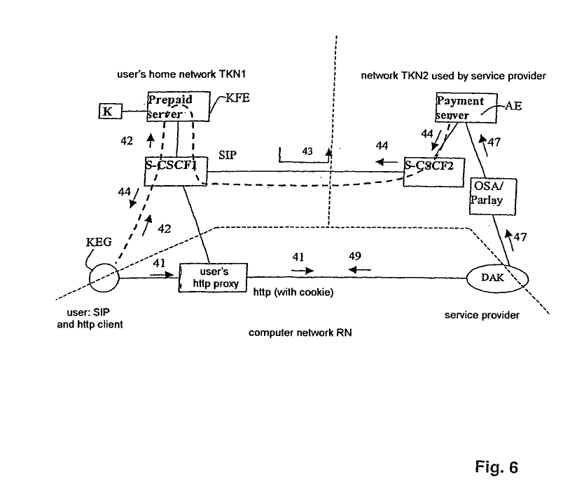

FIG. 6 shows a schematic illustration of network elements with a further exemplary embodiment of the inventive method.

The bottom part of FIG. 1 shows a detail from a computer network RN in which there are a network computer NR associated with a service user and a service provider node DAK associated with a service provider. The service user wishes to use his network computer NR (which is connected to the computer network, by means of a modem dialup connection, for example) in order to use a service which the service provider node DAK provides in the computer network RN (which can be the Internet or else an internal intranet in an organization unit, for example). The service user's network computer RN holds Internet access software (browser, HTTP client, HTTP—Hypertext Transfer Protocol). In addition, the service user has a communication terminal, for example a UMTS mobile telephone, in which an “SIP client” is installed (SIP=Session Initiation Protocol). This SIP client allows the user to set up SIP connections to telecommunication networks.

The user has a contractual relationship (mobile telephone agreement) with a UMTS network operator; this network operator's telecommunication network is consequently the user's home network and is referred to as the first telecommunication network TKN1 below. Since the user settles at least some of his telecommunication charges using a credit account (“prepaid method”), the first telecommunication network TKN1 contains a credit account K for the user, which is managed by an account management device KFE. The account management device KFE has a switching center S-CSCF1 (CSCF=Call State Control Function) connected to it.

The service provider wishes to debit service charges from the service user's credit account K for the services which have been provided via his service provider network DAK, i.e. wishes to bill for the services using this account. Since the service provider node is in America, for example, the service provider has an agreement with an American telecommunication network provider which operates the further telecommunication network TKN2. The service provider node is able to use an OSA gateway or a Parley gateway to set up a data link to a billing device (AE) (payment server) in the further telecommunication network 2. The billing device AE is connected to a further switching center S-CSCF2. The further telecommunication network TKN2 is now able to use the further switching center S-CSCF2 to set up a connection to the switching center S-CSCF1 in the first telecommunication network TKN1. This communication connection, which is also called an SIP session, is set up using a telecommunication-connection controlling signaling system. Details regarding the setup of an SIP session in UMTS telecommunication networks can be found in the printed document 3G TS 23.228 Version 1.7.0 dated February 2001 “3^{rd} Generation Partnership Project; Technical Specification Group Services and System Aspects; IP Multimedia (IM) Subsystem-Stage 2”, for example in section 4.4 “Signaling concepts”.

When a service is requested, the user's network computer NR sends a service request message 1 to the service provider node DAK. Such a service request message 1 can be, by way of example, an “http request”, which the service user uses to request a service and which is transmitted using the message transmission protocol http (http=hyper text transfer protocol). Such a service can involve, by way of example, the user requesting a URL (URL=uniform resource locator), that is to say a web page, a film or a music file, for example. The service request message 1 is sent to the user's “http-proxy”, which forms an intermediate node ZK between the network computer NR and the service provider node DAK. The intermediate node ZK adds an explicit identification for the service user to the service request message 1 using a “cookie”. This explicit identification can be, by way of example, the user's MSISDN, his SIP address or else a special pseudonym identification (agreed with the home network operator). The service request message 1 is then forwarded from the intermediate node ZK to the service provider node DAK. Next, the service provider node DAK sends a reservation message 3 to the billing device AE in the further telecommunication network TKN2, with the reservation message 3 being transmitted via the OSA gateway or the Parlay gateway. Besides the service user's identification, the reservation message 3 also contains the statement indicating a reservation sum which needs to be reserved in the user's credit account for the purpose of billing for the requested service. The level of this reservation sum is dependent on the requested service. The billing device AE now sets up an SIP connection to the user's SIP client, and to this end it sends a reservation request message 4, provided with the service user's identification and with the reservation sum, to the first telecommunication network TKN1, the destination address indicated for this reservation request message 4 being the SIP address of the service user's SIP client. This address is taken as a basis for sending the reservation request message 4 via the SIP connection to the first switching center S-CSCF1 in the first telecommunication network 1. The first switching center S-CSCF1 in the first telecommunication network TKN1 (the user's home network) filters the passing SIP messages and forwards such SIP messages, which contain billing-related information, to the account management device KFE in the first telecommunication network TKN1. In this case, the reservation request message 4 is thus forwarded to the account management device KFE. The account management device KFE terminates the SIP connection and does not forward the SIP messages, in this case the reservation request message 4, even though they have been addressed to the user's SIP client. The account management device KFE recognizes the credit account K associated with the service user from the service user's identification which has also been sent and reserves a sum corresponding to the reservation sum from the credit which is available in this credit account. If the credit account holds the corresponding credit and therefore the reservation proceeds successfully, then the account management device KFE uses the signaling connection SIP to send a reservation request confirmation 5 back to the further telecommunication network TKN2. The second switching center S-CSCF2 forwards this message to the billing device AE. The billing device AE then sends a reservation confirmation 6 to the service provider node DAK via the OSA gateway or the Parlay gateway. The service provider node DAK then has the information that the service which it is to provide has a corresponding sum of money reserved for it in the credit account K, and therefore payment for the service is assured. The service provider node DAK then send a billing message 7 back to the billing device AE. This billing message 7 contains the service user's identification and the specific sum which is to be settled for the service which is to be provided. The billing device AE then uses the telecommunication-connection controlling signaling connection, or the telecommunication-connection controlling signaling system SIP used for this, to send a charging message 8, provided with the service user's identification, to the account management device KFE in the first telecommunication network TKN1. In this case, this charging message 8 is transmitted in a similar manner to the aforementioned reservation request message 4. The charging message 8 likewise contains the sum which is to be settled for the service, so that arrival of the charging message 8 at the account management device can be followed by the latter debiting the corresponding sum from the credit account K. The corresponding sum is thus debited from the credit account's credit. The account management device stores all the information required in connection with this debit operation, said information likewise having been transmitted to the account management device KFE in the charging message 8. Such information is, by way of example, the date, the time, the service provider's identity, the type of service, the service user's identification. The actual financial settlement of the services generally takes place at a later time, outside of the method presented here. To this end, conventional methods are used to transmit financial means, for example by means of bank transfers, from the network operator in the first telecommunication network TKN1 to the network operator in the further telecommunication network TKN2; this network operator in the further telecommunication network TKN2 then transmits the financial means on to the service provider at the service provider node DAK. The service provider node DAK can then provide the service for the service user by transmitting a message (http response) to the service user's network computer NR. This message can be used to transfer information or files, for example, to the service user. A particular advantage of the method described is that the service provider node DAK always sends all information relating to the billing (that is to say the reservation message 3 and the billing message 7, for example) to the same network element, namely to the billing device AE in the further telecommunication network TKN 2. This is done regardless of which user needs to be billed for provision of a service. It is likewise irrelevant to the service provider node DAK which telecommunication network is the user's home network, i.e. which network contains the credit account. The service provider thus needs to have just a single contractual relationship with the operator of the further telecommunication network TKN2 and also needs to be able to set up a data link, as provided via the OSA gateway or the Parlay gateway in this example, only to the billing device AE in this further telecommunication network. The billing device AE then forwards the corresponding messages using the telecommunication-connection controlling signaling system SIP or using the SIP session which has been set up using this system, the messages being routed to the respective account management device KFE in the user's respective home network by a packet-oriented message routing mechanism in the signaling system on the basis of the service user's identification used as address.

This message can be understood to mean that the further telecommunication network TKN2 undertakes collection for the service provider.

The reservation of a sum in a credit account, which is preceded in the exemplary embodiment by the sending of the billing message 7, is optional and can also be dispensed with. By way of example, it is thus likewise possible for the service provider node DAK to create the billing message 7 and to send it to the billing device immediately after receiving the service request message 1. Reservation is not absolutely necessary, particularly if the credit account is debited before the service is provided. In the event of the credit account then not having sufficient coverage, the service is not provided.

A fundamental characteristic of the invention is that information required for billing such services can be transmitted via a telecommunication-connection controlling signaling system in UMTS networks even in such cases as those in which the actual service is provided for a service user whose network computer is situated outside of the UMTS telecommunication network and can be addressed not using the SIP session but rather using another protocol (e.g. the http protocol using an “http session” or else using special protocols—e.g. for games). The invention additionally involves setup of an SIP session, which is used exclusively for billing for the service (also called charging), regardless of the http session which sets up services (so called by way of example).

For the purpose of communication between the service provider node DAK and the further telecommunication network TKN2, it is advantageously possible to use all suitable service control protocols, even if they are not designed on the basis of a generally recognized standard. This is made possible by virtue of the service provider node DAK always having to communicate with just one further telecommunication network TKN2 (even in the case of service users who are domiciled in different telecommunication networks). It is therefore possible for the service provider node DAK and the further telecommunication network TKN2 to communicate on the basis of “dedicated rules” (i.e. using proprietary protocols, for example) . The OSA and Parlay gateways mentioned in connection with the figures and the corresponding OSA and Parlay protocols are thus just two of a large number of possible communication options which can be used.

As an additional option which increases security, provision is made for debiting the requested sum from the credit account K to be preceded by the account management device KFE using the signaling system to send a confirmation request 10 to an SIP client associated with the user. This SIP client can be the user's UMTS mobile telephone, for example. This confirmation request 10 is used to transmit the sum and optionally further descriptions of the service to the user on his mobile telephone's display, for example. The user is asked to confirm the debiting of this sum from his credit account. Only after this confirmation is a corresponding confirmation message 10 returned to the account management device KFE, and the account management device KFE debits the credit account K if the user is in agreement.

Details relating to the sending of such a confirmation request can likewise be found in the aforementioned printed document 23.228 in version 2.0.0. Such an optional confirmation request is advantageous because it is used by an entity (account management device KFE) which is independent of the service provider to check whether the sum invoiced by the service provider is agreed to by the user. This confirmation can also be protected, if appropriate, using an additional password request.

The method described can be used to bill for a wide diversity of services provided in computer networks using a wide variety of protocols (http=hyper text transfer protocol, WAP=wireless application protocol, proprietary protocols for games etc.) on the basis of the Internet protocol IP, for example. The method allows service providers to invoice the users for the costs for service use using their UMTS home network operator's prepaid payment method. When charging information is interchanged between the various telecommunication networks, it is necessary to assure the addressing of messages, the routing of messages and the security (authenticity, integrity and confidentiality) of the transmitted messages. Advantageously, the inventive method uses the already existing infrastructure of UMTS networks for this purpose, so that it is not necessary to develop and set up a second infrastructure, ensuring the security of the transmitted messages, with new network nodes specifically for transmitting messages which relate to billing. As a further advantage, no alterations are necessary on the UMTS terminal (user's SIP client) since all UMTS terminals have an SIP stack and are thus capable of using the SIP protocol (which is used in the telecommunication-connection controlling signaling system).

The method described advantageously uses the following mechanisms:

Addressing and Routing:

To interchange the billing messages between the various telecommunication networks, the routing mechanisms used for the SIP session control are used. In this case, the billing messages are routed between the networks along the same path as the messages for the session control would be routed. The billing messages can have a different entry or exit point, however; by way of example, they can terminate at other network nodes. One possible termination point is the account management device KFE (the prepaid server) in the user's home network. One possible entry point is the. billing device AE (the payment server in the further telecommunication network TKN2). The account management device KFE can be found using the existing routing mechanisms, since it is situated in the session control's path. To this end, the further telecommunication network TKN2 does not need to be made aware of the address of the account management device KFE. This is of particular advantage because, for security and competition reasons, it is in the interests of the operator of the first telecommunication network TKN1 to avoid issuing his prepaid server addresses to operators of other telecommunication networks. This allows the operator of the first telecommunication network TKN1 to reduce inferences about the internal structure of his network, which is again advantageous to him. The account management device KFE needs to be known only to the first switching center S-CSCF1 in the first telecommunication network TKN1. This first switching center has a filter function, filters the billing messages from the stream of SIP messages and forwards them to their destination (for example to the account management device KFE).

Security Mechanisms:

The billing messages are advantageously interchanged between the various telecommunication networks using the same mechanisms as are used in the SIP session control for authentication, integrity protection and protection of confidentiality.

FIG. 2 shows a summary of the messages required for billing (billing messages) which are transmitted in and between the networks shown in FIG. 1. In this case, the reference symbols in FIGS. 1 and 2 correspond to one another.

FIG. 3 shows a further method for billing for services in detail. The service user's network computer NR sends a service request message 21 to the service provider node DAK. The intermediate node ZK arranged between the network computer NR and the service provider node DAK receives the service request message 21 from the service user's network computer and then sends a payment flagging message 22, provided with an identifier for the service user, to the first telecommunication network TKN1 using an SIP session. The first switching centre S-CSCF1 recognizes that the payment flagging message is a billing message intended for the account management device KFE and forwards the payment flagging message 22 to the account management device KFE. The account management device then replaces the service user's identifier transmitted with the payment flagging message 22 with an identification for the service user and returns the message to the first switching center S-CSCF1. Replacing the identifier with the identification allows the service user to be kept anonymous, which means that he cannot be recognized from the identification. The payment flagging message 23 (altered by the replacement) is now sent to the further telecommunication network TKN2 using the telecommunication-connection controlling signaling system SIP. In the further telecommunication network TKN2, the payment flagging message 23 reaches the further switching center S-CSCF2, and this switching center filters the stream of SIP messages, recognizes that the payment flagging message 23 is intended for the billing device AE and forwards the message to the billing device AE. The billing device AE terminates the SIP connection and does not forward the payment flagging message 23, even though it is addressed to the service provider. The billing device AE stores the service user's identification received with the payment flagging message 23 and confirms receipt of the payment flagging message 23 by sending a payment flagging confirmation 24, containing the identification, to the intermediate node ZK, which was the sender of the first SIP message of course. The intermediate node ZK (http proxy) receives the payment flagging confirmation 24 with the identification, appends this identification to the service request message 21 stored in it and forwards the service request message 21 to the service provider node DAK. The identification can in turn be appended using a “cookie”. All further service request messages from the service user also have the identification added to them in the form of this cookie, for example. The service provider node DAK now creates a billing message 27 provided with the service user's identification and forwards this billing message to the billing device AE in the further telecommunication network 2 via the OSA gateway or the Parlay gateway. The billing device AE then uses the signaling system, in a known manner, to send a charging message 28 via the second switching center S-CSCF2 and the first switching center S-CSCF1 to the account management device KFE in the first telecommunication network TKN1. The account management device KFE then bills for the service using the credit account K. Optionally, debiting of the credit account K can be preceded, as shown in connection with FIG. 1, by the sending of a confirmation request to the user's SIP client. Upon confirmation of the sum which is to be debited on the user's SIP client, this sum is debited from the credit sum in the credit account. Successful debiting (deduction) of the requested sum from the credit account K is then in turn communicated by the account management device KFE via the two switching centers to the debiting device AE, which for its part sends a confirmation to the service provider node DAK. The service provider node DAK then provides the service for the service user's http client by sending, by way of example, a provision of service message 29 (http response) to the service user's http client.

FIG. 4 and FIG. 5 show, once again in summarized form, the message flows already explained in connection with FIG. 3 between the network elements.

FIG. 6 shows another exemplary embodiment of the inventive method. A fundamental difference from the method described in connection with FIGS. 3 to 5 is that in FIG. 6 the SIP client and the http client of the service user are implemented together in a communication terminal associated with the service user (e.g. in his UMTS mobile telephone). The service user therefore now need use just one appliance in order both to request services and to allow billing for these services. The service user's communication terminal KEG routes a payment flagging message 42, provided with an identifier for the service user, to the account management device KFE in the first telecommunication network TKN1 using an SIP session. This account management device KFE replaces the user's identifier with an identification for the user and thus hides the service user's identity. In order for the account management device to replace the identifier with the identification, it should be noted in this context that—if it is not necessary for the user to be anonymous—it is also possible for the identifier not to be replaced, which means that the identifier is included when the further messages are sent. This even simplifies the method, which means that it is possible to dispense with replacing the identifier with the identification when the service user's anonymity is not wanted.

However, it will subsequently be assumed that a replacement is made. The altered payment flagging message 43 is now routed to the billing device AE in the second telecommunication network TKN2 using the signaling system SIP in a known manner and hence an SIP connection or SIP session is set up between the first telecommunication network TKN1 and the second telecommunication network TKN2. When the payment flagging message 43 has been received, the billing device AE stores the identification and receipt of this payment flagging message 43 is confirmed by sending a payment flagging confirmation 44, containing the identification, to the communication terminal KEG. The SIP client of the communication terminal KEG receives the payment flagging confirmation 44, and the identification is extracted therefrom and is transferred to the communication terminal's http client. The http client forwards the identification together with the service request message 41 to the service provider node DAK via the intermediate node ZK. The service provider node can now produce a billing message 47 in a known manner and can transmit it to the billing device AE in the second telecommunication network TKN2. The billing device AE then sends a charging message, in a known manner which is similar to FIGS. 1 and 3, to the account management device KFE using the already existing SIP session, and the account management device debits the sum which is to be paid for the service from the service user's credit account K.

FIG. 6 shows the communication terminal KEG both as part of the first telecommunication network TKN1 and as part of the computer network RN. This is symbolized by virtue of the communication terminal KEG covering the boundary shown in dashes, between the two networks.

This takes account of the circumstance that modern UMTS mobile telephones can be used both to perform classical telecommunication services (e.g. voice services) and to make data requests on the Internet (data services) . Browsing on the Internet is possible when an http client is available, because UMTS mobile telephones have an IP stack and an IP access facility. It is therefore possible to regard a UMTS mobile telephone as a special type of Internet computer as well.

It should also be remembered in the case of the separation, shown symbolically in FIGS. 1 and 3, between the telecommunication network and the computer network that particularly the SIP client and the http client cannot always be assigned just exclusively to one network. The separation symbolized by the dashed line is therefore used more for clarity than for an exact separation.

It is true for all exemplary embodiments that the switching centers S-CSCF1 and S-CSCF2 perform a filter function by filtering all incoming SIP messages and hence examining them to determine whether they are involved with the billing for services (whether they are “billing messages”). In this case, the SIP messages are not transmitted to the addresses indicated in their address field (that is to say, not to the service provider or the service user in this case), but rather these SIP messages are forwarded to the network elements which are responsible for the billing (that is to say, by way of example, to the account management device KFE or to the billing device AE).

The billing messages used can, in principle, be any SIP session control messages, particularly those which can be used to transmit the billing information. Examples of these are INVITE, 200 OK, 183 PROVISIONAL RESPONSE, COMET, INFO. By way of example, as the first SIP message to be transmitted, it is possible to use the message INVITE, which is followed by the message “200 OK”. The message “200 OK” and the message “INFO” contain a field into which it is possible to embed the information required for billing (service user's identification, debit sum, reservation sum etc.).

It is also generally true for the exemplary embodiments that as soon as the user has an identification or such an identification is transmitted to him by the telecommunication network TKN1, this identification is included, e.g. using a cookie, in the transmission of all service requests from the user. This means that one and the same identification for the user can be used a plurality of times, for example if the user requests a plurality of music files in succession from the service provider node and thus has a plurality of services provided.

The use of the inventive method also results in the following advantages:

Advantages for the Service Provider:

The service provider is given the opportunity to invoice the user for the costs for using the service using the user's UMTS home network operator's prepaid payment method. This complements other methods or makes them unnecessary. Specific advantages of the method are as follows:

The method is economical even for very small sums.

The user does not need to register (subscribe) with the service provider, which is normally a sticking point.

No security-related data (e.g. credit card number, account details) need to be transmitted via the unsecure user-network operator link.

The risk of loss of claims is very low with prepaid users.

There are a large number of potential customers, specifically, by way of example, both the users of the service provider's network (i.e. of the further telecommunication network TKN2) and the users of other networks with which the service provider's network has a business relationship (in this case, the service users do not even need to be logged into the service provider's network).

From the point of view of the service provider, it is only necessary to connect to the further telecommunication network TKN2 (that is to say to a network belonging to a single operator) in order to be able to provide services independently of operator. It is not necessary to have business relationships with other network operators from the point of view of the service provider, which saves costs and complexity.

If the option of the user's declaration of agreement (“confirmation request”) is used, then the claim cannot subsequently be disputed by the user, since a third party, namely the operator of the home network (the first telecommunication network TKN1), can appear as a “witness”.

Advantages for the Service User:

The user does not need to register (subscribe) with the service provider.

The user can use the service anonymously.

No security-related data (e.g. credit card number, account details) need to be transmitted via the unsecure user-network operator link.

If the option of the user's declaration of agreement is used, the user is certain that only the indicated sum will be invoiced.

Advantages for the Network Operator:

It is possible to collect charges for providing the infrastructure which service providers use for charging for services.

The network operator's attractiveness to other network operators increases by virtue of the opportunity to be able to pay for chargeable services using the prepaid account.

1. A method for billing for services provided in a computer network (RN), in which service use by a service user domiciled in a first telecommunication network (TKN1) involves
a service provider node (DAK) in the computer network (RN) sending a billing message (7, 27, 47), provided with an identification for the service user, to a billing device (AE) in a further telecommunication network (TKN2) which can be connected to the computer network,
the further telecommunication network (TKN2) taking the service user's identification as a basis for using a telecommunication-connection controlling signaling system (SIP) to send a charging message (8, 28), provided with the service user's identification, to an account management device (KFE) in the service user's first telecommunication network (TKN1), and
the account management device (KFE) billing for the service use via a credit account (K) associated with the service user.

2. The method as claimed in one of the preceding claims, characterized in that
the first telecommunication network (TKN1) and/or the further telecommunication network (TKN2) are operated according to UMTS guidelines.

3. The method as claimed in one of the preceding claims, characterized in that
the charging message (8, 28) is routed to the account management device (KFE) by a packet-oriented message routing mechanism in the signaling system (SIP).

4. The method as claimed in one of the preceding claims, characterized in that
a signaling system (SIP) is used in which a message transmission protocol called “Session Initiation Protocol” is applied.

5. The method as claimed in one of the preceding claims, characterized in that
the computer network is connected to the further telecommunication network (TKN2) by means of a Parlay network connection node (Parlay gateway) or by means of an OSA network connection node (OSA gateway).

6. The method as claimed in one of the preceding claims, characterized in that
before the billing message (7) is sent
the service provider node (DAK) receives a service request message (1) with the service user's identification,
the service provider node (DAK) then creates a reservation message (3) with a reservation sum associated with the requested service,
this reservation message (3) is sent together with the service user's identification to the billing device (AE) in the further telecommunication network (TKN2),
the further telecommunication network (TKN2) uses the telecommunication-connection controlling signaling system (SIP) to send a reservation request message (4), provided with the service user's identification and with the reservation sum, to the account management device (KFE), and
upon successful reservation the account management device (KFE) sends a reservation request confirmation (5) to the billing device (AE) via the signaling connection,
the service provider node (DAK) then creates the billing message (7) and provides the service (9).

7. The method as claimed in one of claims 1 to 5, characterized in that
before the billing message (27) is sent
a network computer (NR) associated with the service user is used to send a service request message (21) to the service provider node (DAK),
an intermediate node (ZK) arranged between the network computer (NR) and the service provider node (DAK) on the basis of message flow routes a payment flagging message (22), provided with an identifier for the service user, to the account management device (KFE) in the first telecommunication network (TKN1),
this account management device (KFE) replaces the identifier with the service user's identification,
the altered payment flagging message (23) is then routed to the billing device (AE) in the further telecommunication network (TKN2) via the telecommunication-connection controlling signaling system (SIP),
the billing device (AE) stores the identification and confirms receipt of the altered payment flagging message (23) to the intermediate node (ZK) by sending a payment flagging confirmation (24) which contains the identification,
the intermediate node (ZK) then forwards the service request message (21) together with the identification to the service provider node (DAK), and
the service provider node (DAK) then creates the billing message (27) and provides the service (29).

8. The method as claimed in one of claims 1 to 5, characterized in that
before the billing message (47) is sent
a communication terminal (KEG) associated with the service user is used to route a payment flagging message (42), provided with an identifier for the service user, to the account management device (KFE) in the first telecommunication network (TKN1),
this account management device (KFE) replaces the identifier with the service user's identification,
the altered payment flagging message (43) is then routed to the billing device (AE) in the further telecommunication network (TKN2) via the telecommunication-connection controlling signaling system (SIP),
the billing device (AE) stores the identification and confirms receipt of the altered payment flagging message (43) to the communication terminal (KEG) by sending a payment flagging confirmation (44) which contains the identification,
the communication terminal (KEG) then forwards a service request message (41) together with the identification to the service provider node (DAK), and
the service provider node (DAK) then creates the billing message (47) and provides the service (49).

9. The method as claimed in one of claims 1 to 5, characterized in that
before the billing message (7) is sent the service provider node (DAK) receives a service request message (1) with the service user's identification, and
the service provider node (DAK) then creates the billing message (7) and provides the service (9).
